(19) United States
(12) Patent Application Publication
(10) Pub. No.: US 2013/0173317 A1
(43) Pub. Date: Jul. 4, 2013

(54) EVENT BOOKING SYSTEM

(71) Applicant: Brainy Heads Inc., Redwood City, CA (US)

(72) Inventor: Amr Higgy, Redwood City, CA (US)

(73) Assignee: BRAINY HEADS INC., Redwood City, CA (US)

(21) Appl. No.: 13/729,216

(22) Filed: Dec. 28, 2012

Related U.S. Application Data
(60) Provisional application No. 61/582,360, filed on Jan. 1, 2012.

(51) Int. Cl. G06Q 10/02

(52) U.S. Cl. CPC G06Q 10/02
USPC 705/5

(57) ABSTRACT

A system and method alleviates a risk of booking an undersold event by facilitating an agreement between a performer and a venue operator, a performer and a promoter, or a venue operator and a promoter on tentative ticket reservations for consumers. If a threshold relating to the tentative ticket reservations is achieved, then the event is booked, each tentative ticket reservation is executed, and the consumer is charged. If the threshold is not achieved, the event is abandoned and each tentative ticket reservation is cancelled.

### CROSS-REFERENCE TO RELATED APPLICATION(S)

This application claims priority under 35 U.S.C. §119(e) of the U.S. Provisional Patent Application Ser. No. 61/582,360 filed Jan. 1, 2012 and titled, “Performer, Performance, Demand and Party Contract Management Application; with Group Purchasing Platform.” Provisional Patent Application Ser. No. 61/582,360 is also hereby incorporated by reference in its entirety for all purposes.

### FIELD OF THE DISCLOSURE

This invention relates generally to the booking of an event at a venue and the sale of tickets to the venue. More specifically, this invention relates to a platform that allows performers, venue operators, promoters, and fans to request the booking of an event at a venue, and negotiate a binding agreement on a threshold for conditional ticket sales to the event such that if the threshold is achieved, a sale is realized and the purchaser is charged, and if the threshold is not achieved, the conditional ticket sale is abandoned.

### BACKGROUND OF THE INVENTION

Every day, thousands of events are booked all over the world at clubs, theaters, and concert halls. They range from small gatherings and fundraisers to large stadium rock concerts and comedy shows. Event promotion, which includes the management of ticket sales, is a multi-billion dollar industry. The industry leader is Ticketmaster®, which focuses on the promotion of large concerts and shows with famous performers. Ticketfly®, Eventbrite®, Eventful® and Stub Hub® are event promotions and ticket-selling services catering to smaller events that may also offer additional services like selling remnant ticket inventories.

Social media is playing an increasing role in facilitating event promotions. Events are inherently social, and people want to share events for many reasons: to gauge a friends' interest in attending, to show off something really cool or unique they've discovered, or to encourage friends to attend with them. Depending on that motivation, people will be more or less likely to share either at the point of discovery or post purchase. The social web fuels the conversation and the communities that surround live events.

In fact, the value of sharing through social media can be assessed in terms of financial transactions. Each share can have an inherent dollar value. Recent studies from Eventbrite® published Mar. 16, 2011 and Oct. 10, 2010 have quantified one share on Facebook® to equal $2.52, one share on Twitter to equal $0.43, one share on LinkedIn to equal $0.90, and one share through Eventbrite's “email friends” application to equal $2.34. See Tamara, “Social Commerce: A Closer Look at the Numbers”, Eventbrite.com/social-commerce-2 accessed Apr. 5, 2012; Tamara, “Social Commerce: A First Look at the Numbers”, Eventbrite.com/social-commerce accessed Apr. 5, 2012. On an aggregate level across Facebook®, Twitter®, LinkedIn®, and their email, each share equals $1.78 in ticket sales. Id. This inherent dollar value of each share is improving weekly with the most recent four-week average equaling $1.87. Every dollar spent acquiring a customer yields a $1.87 worth of ticket purchase return. In addition, the hyper-relevancy of the social graph breeds deeper engagement, greater ticket sales, and stickier audiences. On average, each Facebook® share alone drives 11 visits back to Eventbrite.com®. Id. Averaging across all channels, one share drives over seven visits back to Eventbrite.com®. Id.

Nevertheless, despite the attention focused on the event promotions market, events can remain undersold, resulting in a monetary loss to the promoter, venue operator, and/or performer. The majority of these undersold events take place at smaller venues, though large venues can also struggle with selling enough tickets, especially during off-peak times and/or with new and emerging artists. One particular risk is that booking a new, unknown or out of town artist is a risky business proposition for the venue promoter. The performer's popularity or demand is unable to guarantee enough ticket sales to make the show a profitable venture for all parties.

US Publication No. 2007/0250354 to Neulight describes a system to minimize the risk of an undersold event whereby a promoter pre-sells tickets, before the event is booked. A successful pre-sale of tickets triggers the booking of the event. An unsuccessful pre-sale results in the event not being booked. The problem with this approach is that it depends upon a sophisticated promoter to coordinate the performer and the venue ahead of time, without the help of an automated system. Such promoters will certainly be limited by various contraints and inevitably, performers and venue operators will be overlooked. Furthermore, events involving smaller performers or venues may not even involve a promoter.

Similarly US Publication No. US 2008/0046913 to Dear describes a system whereby a consumer can create a demand for an event at a particular location and then encourage other consumers to join in the demand. Once the demand reaches a threshold, the performer is notified of the demand and asked to agree to the demanded event. However, the problem with this approach is that a consumer may not have the motivation or incentive to go through the trouble of initiating a demand. It does not capture the motivation, incentive of a performers, venue operators, and/or promoters to book an event.

### SUMMARY OF THE INVENTION

A system and method alleviates a risk of booking an undersold event by allowing performers, venue operators, and/or performers to reach an agreement for offering tentative ticket reservations to consumers. If a threshold relating to the tentative ticket reservations is achieved, then the event is booked, each tentative ticket reservation is executed, and the consumer is charged. If the threshold is not achieved, the event is abandoned and each tentative ticket reservation is cancelled.

In one aspect of the invention, a system and method of alleviating a risk of booking an undersold event includes obtaining, at a network server, a request to book a venue for an event, facilitating an agreement on a threshold relating to tentative ticket reservations that must be achieved within a certain time period before the event is confirmed, and offering tentative ticket reservations to the event subject to the condition that if the threshold is achieved, each tentative ticket reservation becomes a final sale, and if the threshold is not achieved, the tentative ticket reservation is cancelled. A performer or a venue operator may make the request to book the event, in which case the agreement on the threshold is between the performer and the venue operator. Alternatively, a promoter may make the request to book the event, in which case the agreement on the threshold is between the performer, venue operator, and promoter. The threshold may be based at least in part on the number of tentative ticket reservations that have been accepted, or projected revenues based on tentative ticket reservations.

The system and method further includes receiving at least one acceptance of a tentative ticket reservation from a consumer, as well as determining if the threshold condition has been achieved, and informing the consumer, performer, venue operator, and/or promoter whether or not the threshold condition has been achieved. The system and method may also include providing tracking information regarding progress towards achieving the threshold.

### BRIEF DESCRIPTION OF THE DRAWINGS

Several example embodiments are described with reference to the drawings, wherein like components are provided with like reference numerals. The example embodiments are intended to illustrate, but not to limit, the invention. The drawings include the following figures:

FIG. 1 is a block diagram of an event booking system according to some embodiments.

FIG. 2A is a flowchart illustrating operation of the event booking system when a performer makes a request for an event.

FIG. 2B is a performer registration page according to some embodiments.

FIG. 2C is a dashboard allowing a performer to enter event registration details and an event threshold according to some embodiments.

FIG. 3A is a flowchart illustrating operation of the event booking system when a venue operator makes a request for an event.

FIG. 3B is a venue operator registration page according to some embodiments.

FIG. 3C is a dashboard allowing a venue operator to enter event registration details and an event threshold according to some embodiments.

FIG. 4A is a flowchart illustrating operation of the event booking system when a promoter makes a request for an event.

FIG. 4B is a promoter registration page according to some embodiments.

FIG. 4C is a dashboard allowing a promoter to enter event registration details and an event threshold according to some embodiments.

FIG. 5 is a fan registration page according to some embodiments.

FIG. 6 is a threshold tracking page according to some embodiments.

### DETAILED DESCRIPTION OF THE PREFERRED EMBODIMENT

Embodiments of the present application are directed to an event booking system. Those of ordinary skill in the art will realize that the following detailed description of the event booking system is illustrative only and is not intended to be in any way limiting. Other embodiments of the event booking system will readily suggest themselves to such skilled persons having the benefit of this disclosure.

### Event Booking System

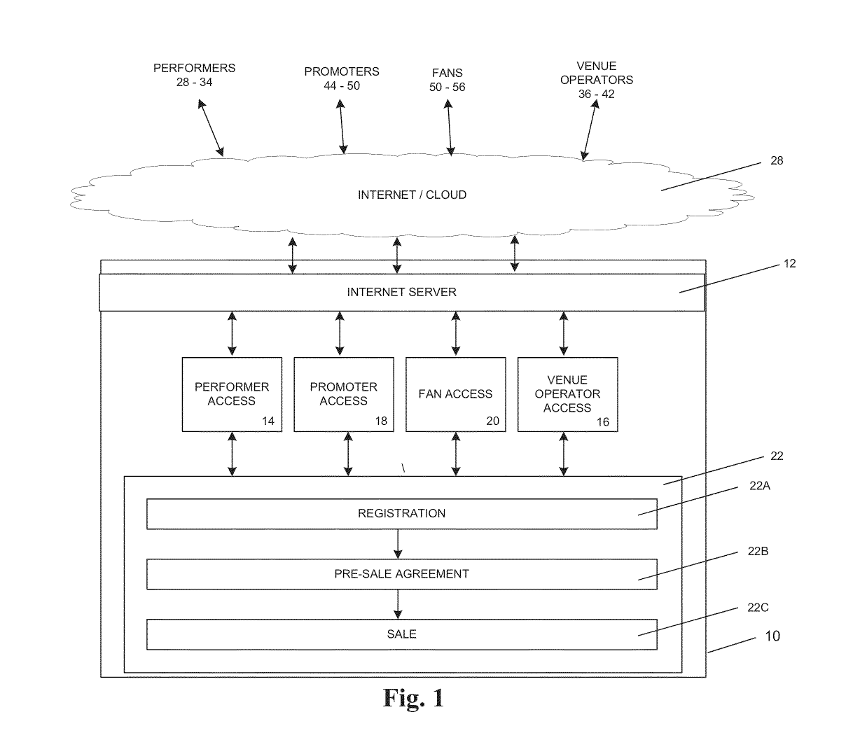

A block diagram of an event booking system in an exemplary environment is illustrated in FIG. 1. An event booking system 10 includes an internet server 12, a performer access system 14, a venue operator access system 16, a promoter access system 18, a fan access system 20, and a process flow 22 which further includes a registration engine 22A, a pre-sale agreement engine 22B, and a sale engine 22C.

The performer access system 14 is coupled to the internet server 12 and to the process flow 22 to control communications between the event booking system and the performers accessing the system. As used herein, “performer” is defined to include, in a traditional sense, artists, musicians, and actors and their agents and employees; as well as in a broader sense, event hosts and their agents and employees. The term event is intended to include performances such as a concert or show, as well as gatherings such as a charity dinner, gallery viewing, etc.

The venue operator access system 16 is coupled to the internet server 12 and to the process flow 22 to control communications between the event booking system and the performers accessing the event booking system. “Venue operator” is defined to include venue owners, and their agents and employees.

The promoter access system 18 is coupled to the internet server 12 and to the process flow 22 to control communications between the event booking system and the performers accessing the event booking system. “Promoter” is defined to be independent from performers and venue operators and may include commercial entities such as radio stations, party promotions companies, an enthusiastic fan or fans, and non-profit entities such that want to organize an event.

The fan access system 20 is coupled to the internet server 12 and to the Process Flow 22 to control communications between the event booking system and the performers accessing the event booking system. “Fan” is defined to include a performer's fan base, regular venue attendees, event attendees, potential event attendees, ticket purchasers, and potential ticket purchasers who register with the event booking system.

The event booking system 10 is coupled to the Internet 28 to allow communications between both the internet server 12 and the performers' computer systems 28-34, venue operators' computer systems 36-42, promoters' computer systems 44-50, and fans' computers 50-56.

In operation, performers can connect with the performer access system 14 using the computer systems 28-34, venue operators can connect with the venue operator access system 16 using computers 36-42, promoters can connect with the promoter access system 18 using the computers 44-50, and fans can connect with the fan access system 20 using the computers 50-56.

### Operation: When a Performer Initiates a Request for an Event

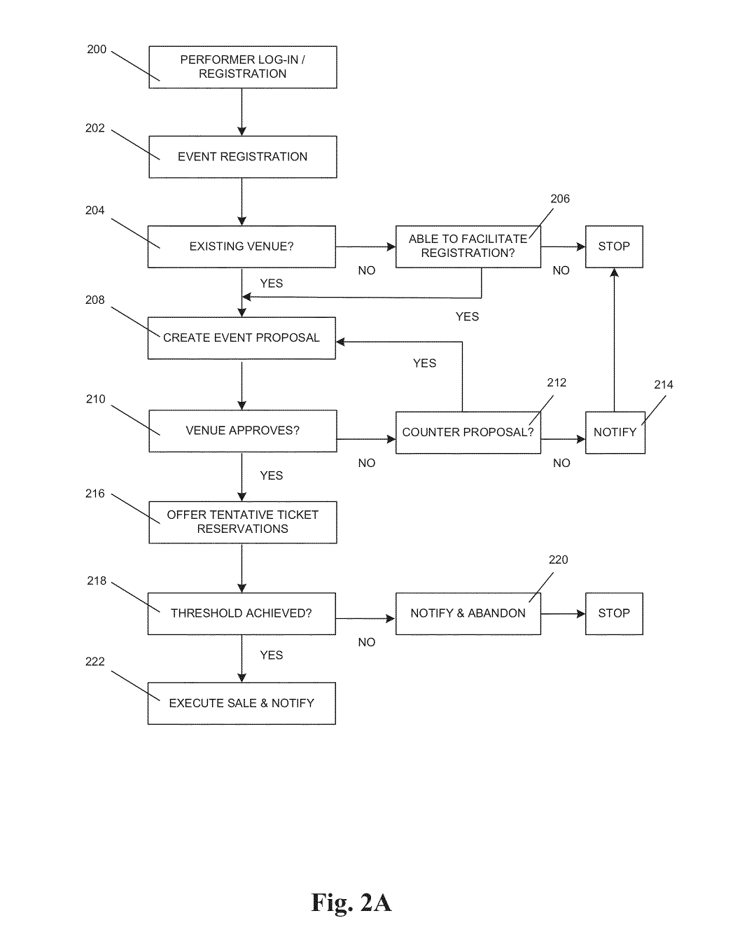

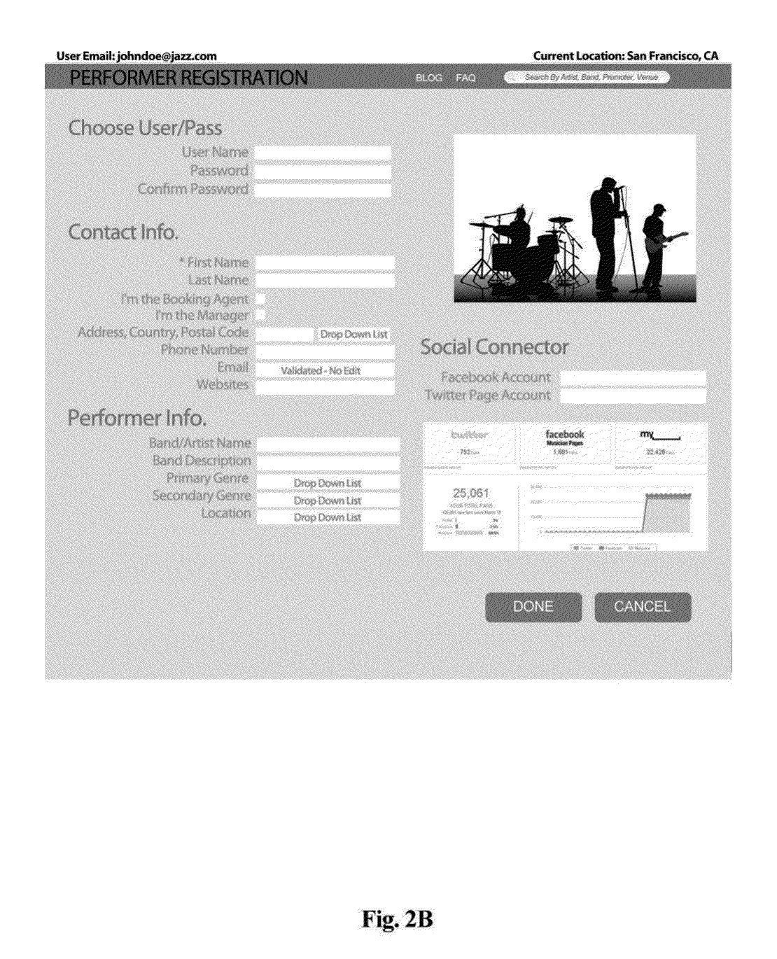

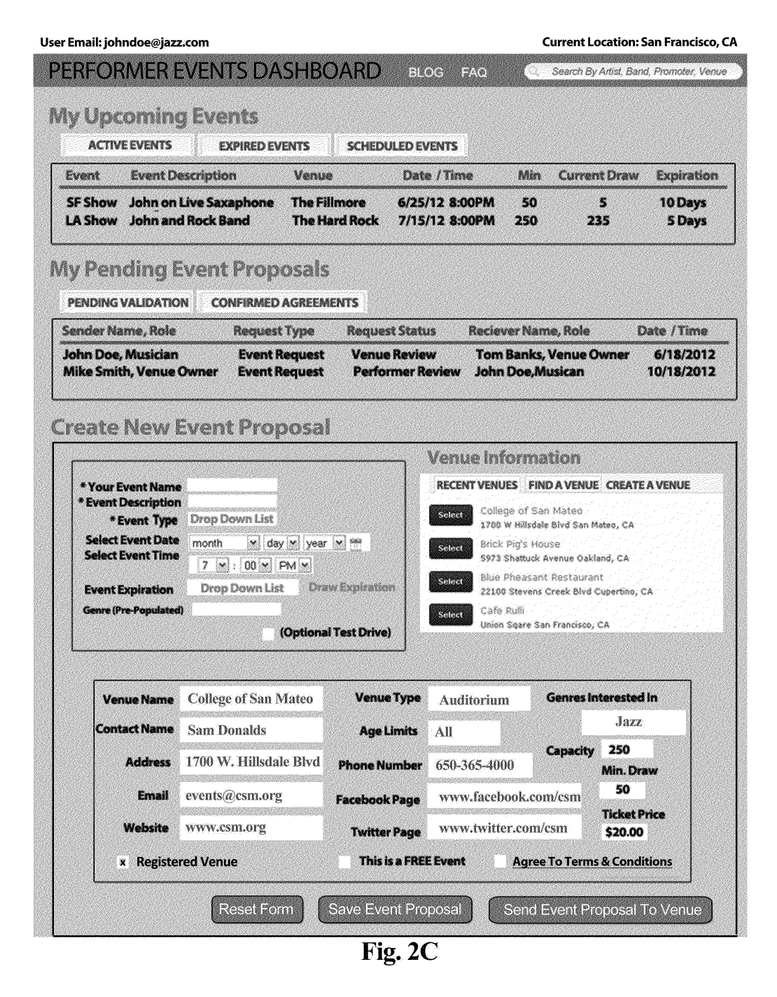

FIG. 2A is a flowchart illustrating the process encountered when a performer makes the initial request for an event. At 200, the performer logs in or registers with the event booking system if it has not already done so. As part of the performer registration process, the event booking system may prompt the performer to populate fields related to contact information, booking agent information, Facebook®, Twitter® or other social media account information, band name, band description, and primary and secondary genres for their performance. FIG. 2B depicts one embodiment of a registration or sign-up page for a performer. It further depicts information measuring the performer's social media connectivity such as graphs regarding the number followers and webpages linking to their social media accounts.

Returning to FIG. 2A, at 202, the performer registers event details and the event booking system may prompt the performer to populate fields related to the date and time of the event, required capacity, required equipment, and required staff or services. The performer may choose a venue from a list of registered venues. In that case, the system proceeds to 208.

Alternatively, the performer may also request a venue that is not on the list. In that case, the system assists the performer in locating the venue operator and attempting to facilitate registration by sending an electronic registration request to the venue operator (206). If the venue operator successfully registers with the event booking system, the system proceeds to 208.

At 208, the performer may be prompted to propose the threshold for tentative ticket reservations, such that if the threshold is achieved, each tentative ticket reservation becomes a final sale and the event is booked, and if the threshold is not achieved, the tentative ticket reservation is cancelled and the event is not booked. The threshold may be based entirely or in part on the total number of tentative tickets sold within a specified period of time, the number of tentative tickets sold at a particular price within a specified period of time, or the total projected revenue from the tentative tickets sold within a specified period of time. In another embodiment, the event booking system will propose the tentative ticket threshold using an algorithm based on information it has about the performer, venue, or event, for approval by the performer. Alternatively, the event booking system may suggest a threshold based upon default values entered by the venue operator, or thresholds used by the venue operator for previous events.

Once the performer enters and/or approves the threshold, the event booking system creates an event proposal that includes the event details, threshold, and default contract terms. The performer may be asked to agree to the specifics of the event proposal and other terms and conditions relating to the booking of the event and use of the event booking system, before the event proposal is sent to the venue operator.

FIG. 2C depicts one embodiment of a dashboard that allows a performer to enter event details and an event threshold according to 202-208 of FIG. 2A. In FIG. 2C, the performer has selected a venue from a list of registered venues, “Recent Venues.” Alternatively, the performer may have selected the venue from a list of registered venues under the “Find A Venue” menu. Because the venue is already registered, the system allows the performer to populate additional fields relating to the threshold relating to tentative ticket reservations, which in this particular embodiment is the “minimum draw” and “ticket price” (208). The performer may also “Create A Venue” for a venue that is not on the list. In that case, the event booking system may assist the performer in locating the venue operator in attempting to facilitate registration by sending an electronic registration request to the venue operator (206). If the venue operator is able to successfully register with the event booking system, the system proceeds to 208 where the performer may enter threshold information relating to tentative ticket reservations. If it is not, event booking system asks the performer to propose a different venue.

Returning to FIG. 2A, at 210, the venue operator may approve the event proposal, creating a binding pre-sale agreement according to its event details, threshold, and default contract terms. The venue operator may also attempt to modify the threshold, event details, and/or default contract terms such that a counter-proposal is sent back to the performer for approval (212). The event booking system may provide back and forth messaging capabilities to further facilitate agreement on the terms. The venue operator may also deny the event request without making a counterproposal (214), in which case the event booking system will notify the performer.

Variations can be made in the negotiation of the pre-sale agreement between the performer and venue operator in 208-214, including the number of counter-proposals that may be made before an agreement is reached or the process is abandoned. Similarly, although a performer may initiate the event request, the event booking system may have the venue operator make the initial threshold proposal, or allow the performer and venue operator to propose different parts of the threshold. The event proposal and negotiations leading up to the pre-sale agreement can occur via electronic packets sent between the performer computer system and venue operator computer system as facilitated by the event booking system 10. Alternatively, the event proposal and negotiations leading up to the pre-sale agreement can occur via instant messaging between the performers and venue operator logged into the event booking system.

At 216, the event booking system offers the tentative ticket reservations to consumers and explains the terms and conditions of the threshold. When a consumer accepts a tentative ticket reservation, they may be required to authorize a hold on their credit card. Alternatively, they may be required to make a deposit. In one embodiment, the event booking system promotes the event by generating messages for sending via social networking. In another, the event booking system maintains its own promotional materials via webpages, showing progress towards achieving the threshold. In yet another, the event booking system sends periodic updates regarding progress.

At 218, the event booking system determines whether the threshold has been achieved. If not, consumers who have made tentative ticket reservations, the performer, and/or the venue operator are notified and the event and reservations are abandoned (220). If the threshold is achieved, each ticket reservation is executed as a sale, and consumers are charged (222). The consumer, performer, and/or venue operator are also notified that the event is booked.

### Operation: When a Venue Operator Initiates a Request for an Event

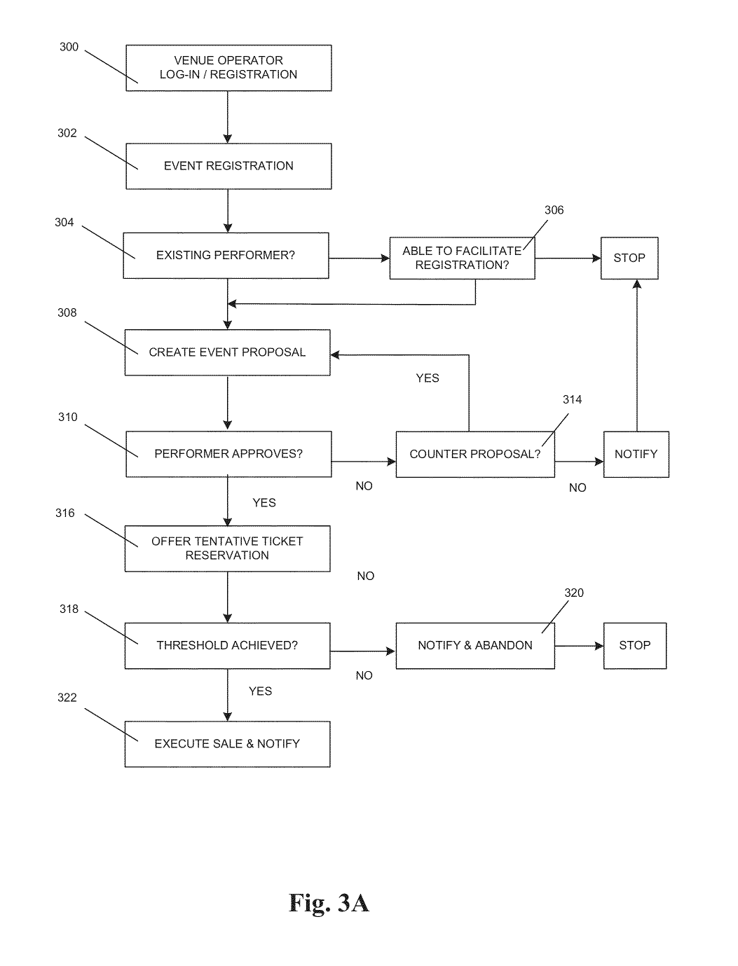

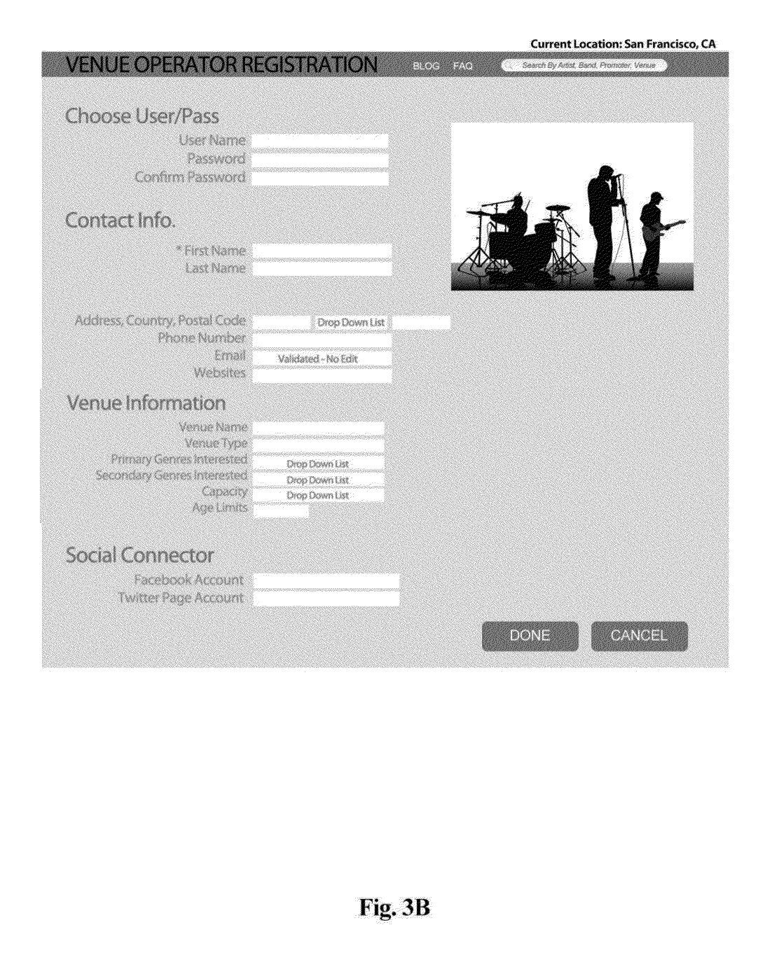

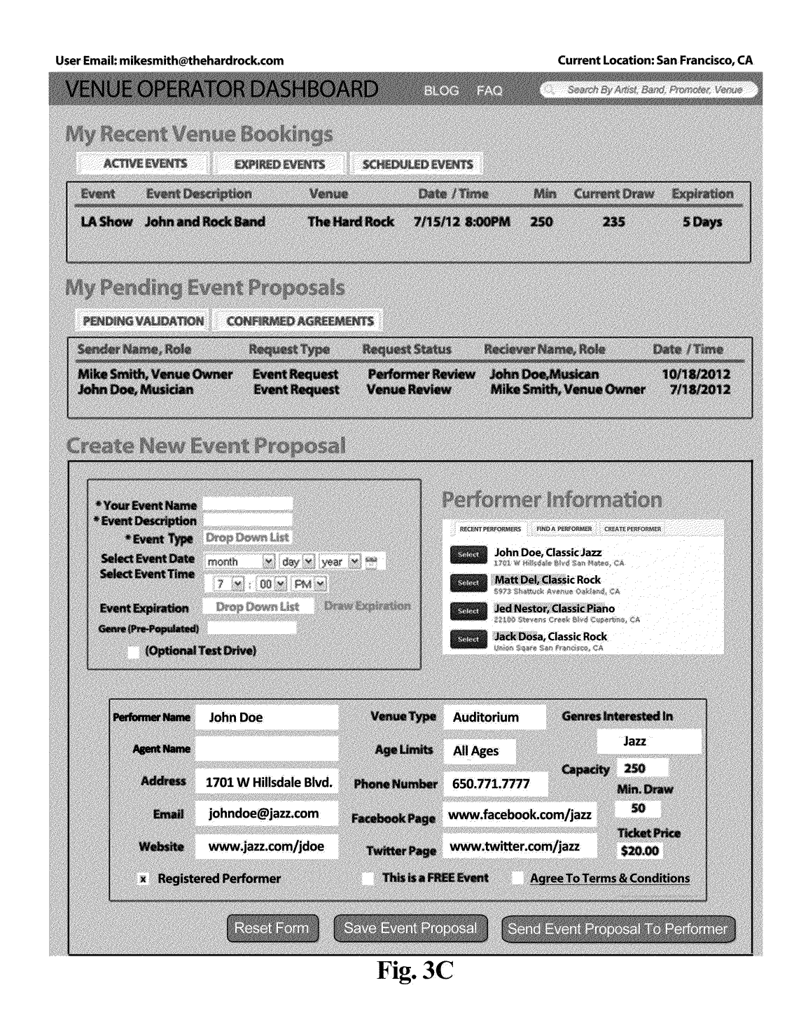

FIG. 3A is a flowchart illustrating a variation to the process when the venue operator registers the event request.

At 300, the venue operator logs in or registers with the event booking system if it has not already done so. As part of the venue operator registration process, the event booking system may prompt the venue operator to populate fields related to contact information, verification of identity, Facebook®, Twitter®, or other social media account information, venue name, venue description, location, capacity, and amenities. FIG. 3B depicts one embodiment of a registration page.

Returning to FIG. 3A, at 302, the venue operator registers event details and the event booking system may prompt the venue operator to populate fields related to the requested performer, date, time, and required staff or services. The venue operator may choose the performer from a pre-existing list of registered performers. In that case, the system proceeds to 308.

Alternatively, the venue operator may also request a performer that is not on the list. In that case, the system assists the venue operator in locating the performer and attempting to facilitate registration by sending an electronic registration request to the performer (306). If the performer successfully registers with the event booking system, the system proceeds to 308.

At 308, the venue operator will be prompted to propose a threshold for tentative ticket reservations, such that if the threshold is achieved and the event is booked, each tentative ticket reservation becomes a final sale, and if the threshold is not achieved, the tentative ticket reservation is cancelled and the event is not booked. In another embodiment, the event booking system will propose the tentative ticket threshold using an algorithm based on information it has about the performer, venue, or event, for approval by the performer. Alternatively, the event booking system may suggest a threshold based upon default values previously entered by the venue operator, or thresholds used before by the venue operator for previous events. Once the venue operator enters and/or approves the threshold, the event booking system creates an event proposal that includes the event details, threshold, and default contract terms. The venue operator may be asked to agree to the specifics of the event proposal and other terms and conditions relating to the booking of the event and use of the event booking system, before the event proposal is sent to the venue performer.

FIG. 3C depicts one embodiment of a dashboard that allows a venue operator to enter event details and an event threshold according to 302-308 of FIG. 3A. In FIG. 3C, the venue operator has selected a venue from a list of registered performers, “Recent Performers.” Alternatively, the venue operator may have selected the venue from a list of registered performers under the “Find A Performer” menu. Because the venue is already registered, the system allows the venue operator to populate additional fields relating to a tentative ticket threshold, which in this particular embodiment is the “minimum draw” and “ticket price” (308). The venue operator may also “Create A Venue” if the venue operator cannot find the venue on the list. In that case, the event booking system will assist the venue operator in locating the performer and attempting to facilitate registration by sending an electronic registration request to the performer (306). If the performer is able to successfully register with the event booking system, the system proceeds to 308 where the venue operator may enter the tentative ticket threshold. If it is not, the event booking system asks the venue operator to propose a different performer.

Returning to FIG. 3A, at 310, the performer may approve the event proposal creating a binding pre-sale agreement according to its event details, threshold, and default contract terms. The performer may also attempt to modify the threshold, event details, or default contract terms such that a counter-proposal 314 is sent back to the performer for approval. The event booking system may provide back and forth messaging capabilities to further facilitate agreement on the event details and threshold. The performer may also deny the event request without making a counterproposal, in which case the event booking system will notify the venue operator. The event proposal and negotiations leading up to the pre-sale agreement can occur via electronic packets sent between the performer computer system and venue operator computer system as facilitated by the event booking system 10. Alternatively, the event proposal and negotiations leading up to the pre-sale agreement can occur via instant messaging between the performer and venue operator when they are logged into the event booking system.

At 316, the event booking system offers the tentative ticket reservations to consumers and explains the terms and conditions of the threshold. In one embodiment, the event booking system promotes the event by generating messages for sending via social networking. In another, the event booking system maintains its own promotional materials via webpages, showing progress towards achieving the threshold. In yet another, the event booking system sends periodic updates regarding progress.

At 318, the event booking system determines whether the threshold has been achieved. If not, consumers who have made tentative ticket reservations, the performer, and/or the venue operator are notified and the event and reservations are abandoned (320). If the threshold is achieved, each ticket reservation is executed as a sale, and consumers are charged (322). The user, performer, and/or venue operator are also notified that the event is booked.

### Operation: When a Promoter Initiates a Request for an Event

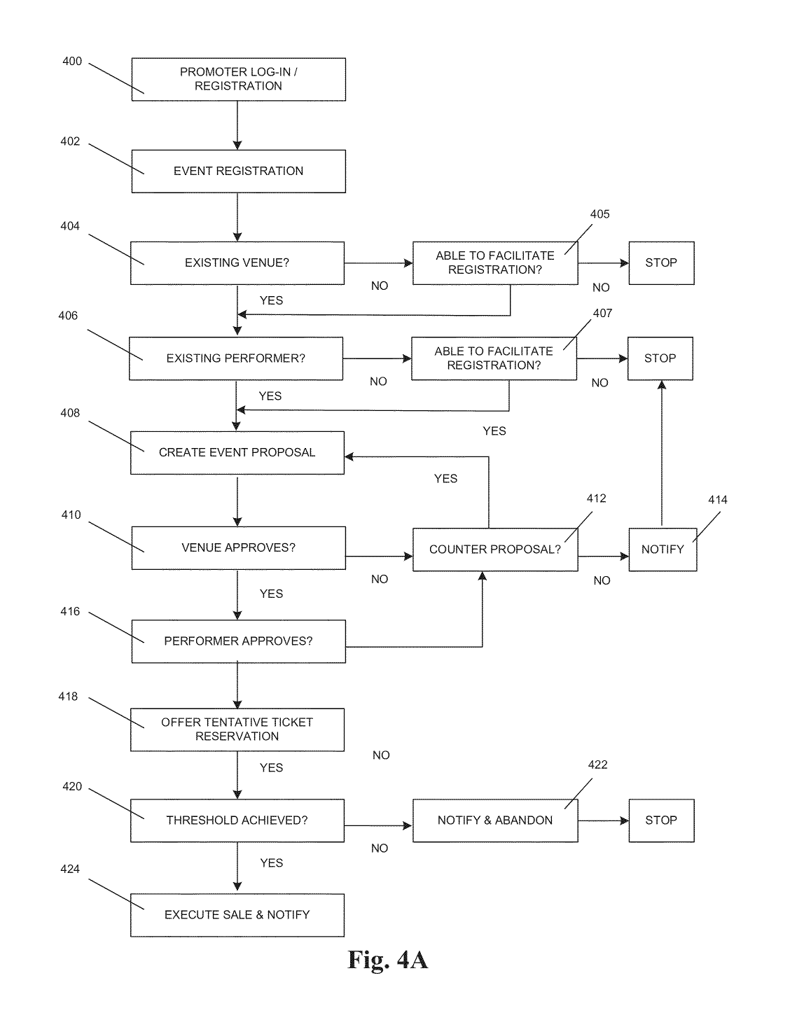

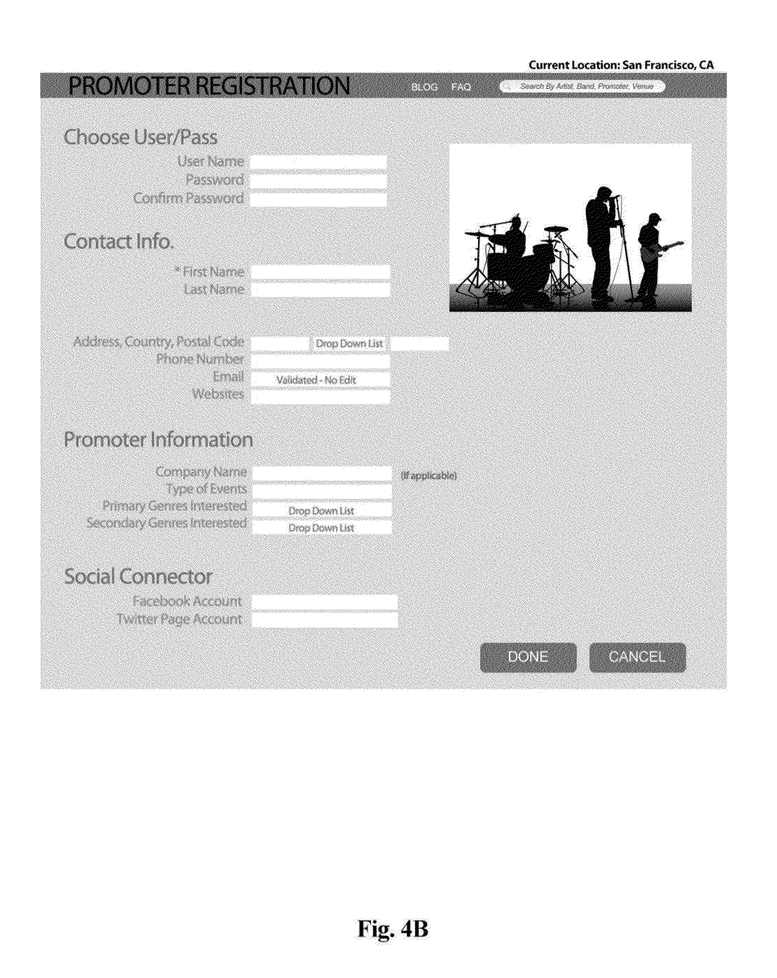

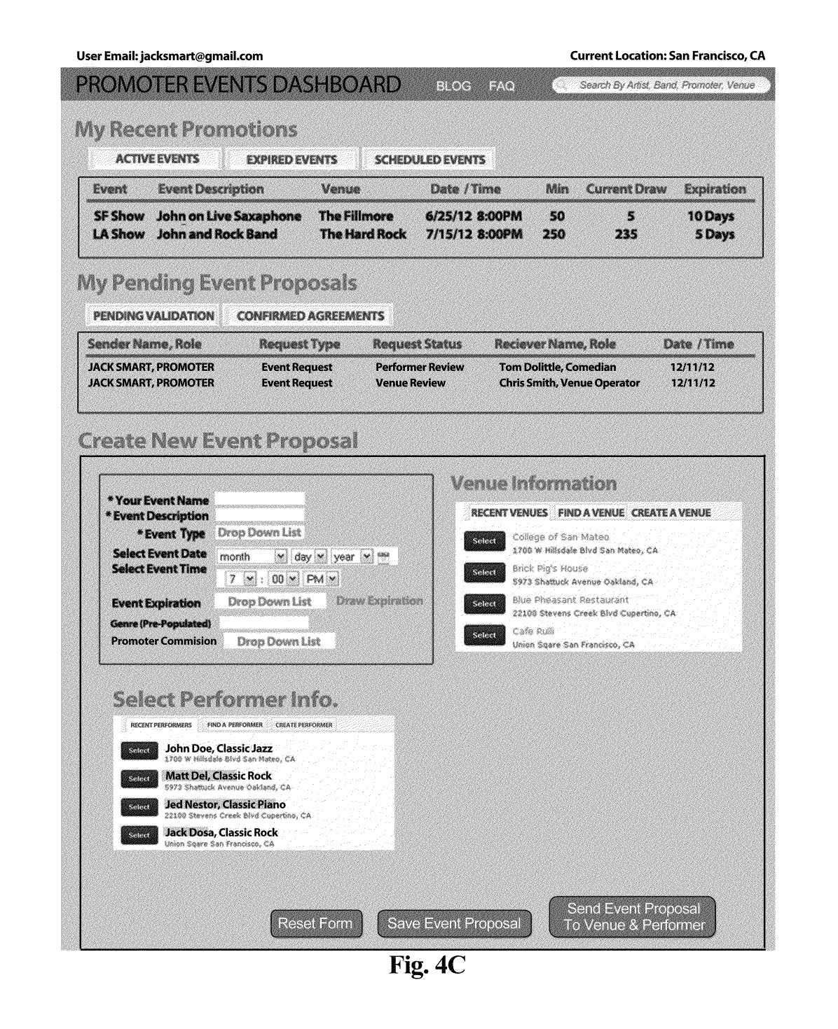

FIG. 4A is a flowchart illustrating a variation to the process when an independent third party promoter registers the event request.

At 400, the promoter logs in or registers with the event booking system if it has not already done so. As part of the promoter registration process, the event booking system may prompt the performer to populate fields related to contact information, verification of identity, Facebook, Twitter®, or other social media account information, primary genre of interest, and secondary genre of interest. FIG. 4B depicts one embodiment of a registration page for a promoter. At 402, the promoter registers event information. The event booking system may prompt the promoter to populate fields related to requested venue, requested performer, date, time, and required staff or services. The promoter may choose a performer from a pre-existing list of registered performers and/or a venue from a pre-existing list of registered venues. Alternatively a promoter may request a performer and/or a venue that is not on the list.

If the promoter requests a venue that is not on the list, the event booking system assists the promoter in attempting to facilitate registration by sending an electronic registration request to the venue operator at 405. If the venue operator successfully registers with the event booking system, the system proceeds to 406 or 408.

If the promoter requests a performer that is not on the list, the event booking system assists the promoter in attempting to facilitate registration by sending an electronic request to the performer at 407. If the performer registers with the event booking system, the system proceeds to 408.

At 408, the promoter will be prompted to propose a threshold for tentative ticket reservations, such that if the threshold is achieved, each tentative ticket reservation becomes a final sale, and if the threshold is not achieved, the tentative ticket reservation is cancelled. In another embodiment, the event booking system will propose the tentative ticket threshold using an algorithm based on information it has about the performer, venue, or event, for approval by the promoter. Alternatively, the event booking system may suggest a threshold based upon default values entered by the venue operator, or thresholds used by the venue operator for previous events. Once the promoter enters and/or approves the threshold, the event booking system creates an event proposal that includes the event details, threshold, and default contract terms. The promoter may be asked to agree to the specifics of the event proposal and other terms and conditions relating to the booking of the event and use of the event booking system, before the event proposal is sent to the venue operator at 410.

FIG. 4C depicts one embodiment of a dashboard allowing a promoter to facilitate 402-408. The description of FIGS. 2C and 3C relating to selection of a venue and performer can be incorporated here to describe the promoter dashboard. It should be further understood that the promoter dashboard may be broken down into more than one page to allow the promoter to enter the relevant information.

Returning to FIG. 4A, at 410, the venue operator may approve the event proposal creating a binding pre-sale agreement according to its event details, threshold, and default contract terms and so that the promoter and venue operator are in agreement and the event proposal is next sent to the performer. The venue operator may also attempt to modify the terms of the threshold such that a counter-proposal 412 is sent back to the promoter for approval. The event booking system may provide back and forth messaging capabilities to further facilitate agreement on the terms. The venue operator may also deny the event request without making a counterproposal in which case the event booking system will notify the promoter (414).

At 416, the performer may approve the event request creating a binding agreement according to the event details, threshold, and default contract terms of the event proposal between the performer, venue operator, and promoter. It may also attempt to modify the terms of the threshold such that a counter-proposal is sent back to the venue operator and promoter for approval. The event booking system may provide back and forth messaging capabilities to further facilitate agreement on the terms. The performer may also deny the event request without making a counterproposal in which case the event booking system will notify the promoter and venue operator (414). Note that in a different embodiment, the order in which the venue operator and performer respond to the event request may be switched. Alternatively, the event proposal may be sent to both the venue operator and performer simultaneously for approval, rejection, or counter-proposal. The event proposal and negotiations leading up to the pre-sale agreement can occur via electronic packets sent between the performer computer system, venue operator computer system, and promoter computer system as facilitated by the event booking system 10. Alternatively, the event proposal and negotiations leading up to the pre-sale agreement can occur via instant messaging between the performer, venue operator, and promoter when they are logged into the event booking system.

At 418, the event booking system offers the tentative ticket reservations to consumers and explains the terms and conditions of the threshold. In one embodiment, the event booking system promotes the event by generating messages for sending via social networking. In another, the event booking system maintains its own promotional materials via webpages, showing progress towards achieving the threshold. In yet another, the event booking system sends periodic updates regarding progress.

At 420, the event booking system determines whether the threshold has been achieved. If not, consumers who have made tentative ticket reservations, performer, venue operator, and/or promoter are notified and the event and reservations are abandoned (422). If the threshold is achieved, each ticket reservation is executed as a sale, and users are charged (424). The consumer, performer, venue operator, and/or promoter are also notified that the event is booked.

### Operation: Fan Access

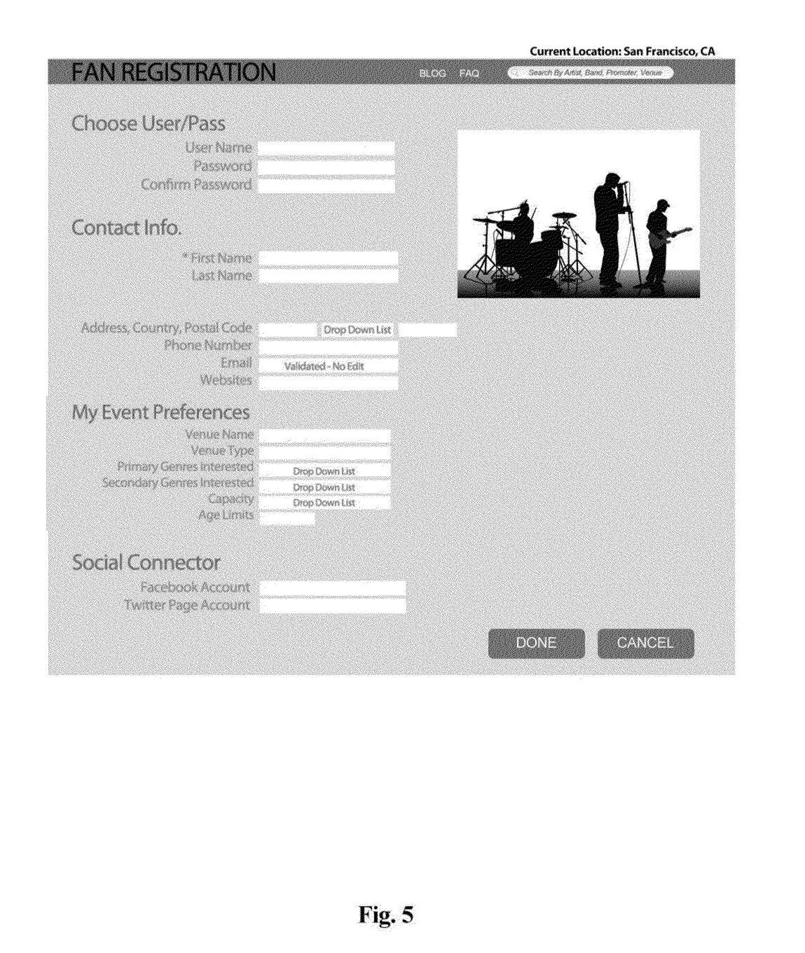

FIG. 5 depicts an embodiment of a fan sign-up page. As part of the fan registration process, the event booking system may prompt the performer to populate fields related to contact information, verification of identity, Facebook®, Twitter®, or other social media account information, primary genre of interest, and secondary genre of interest.

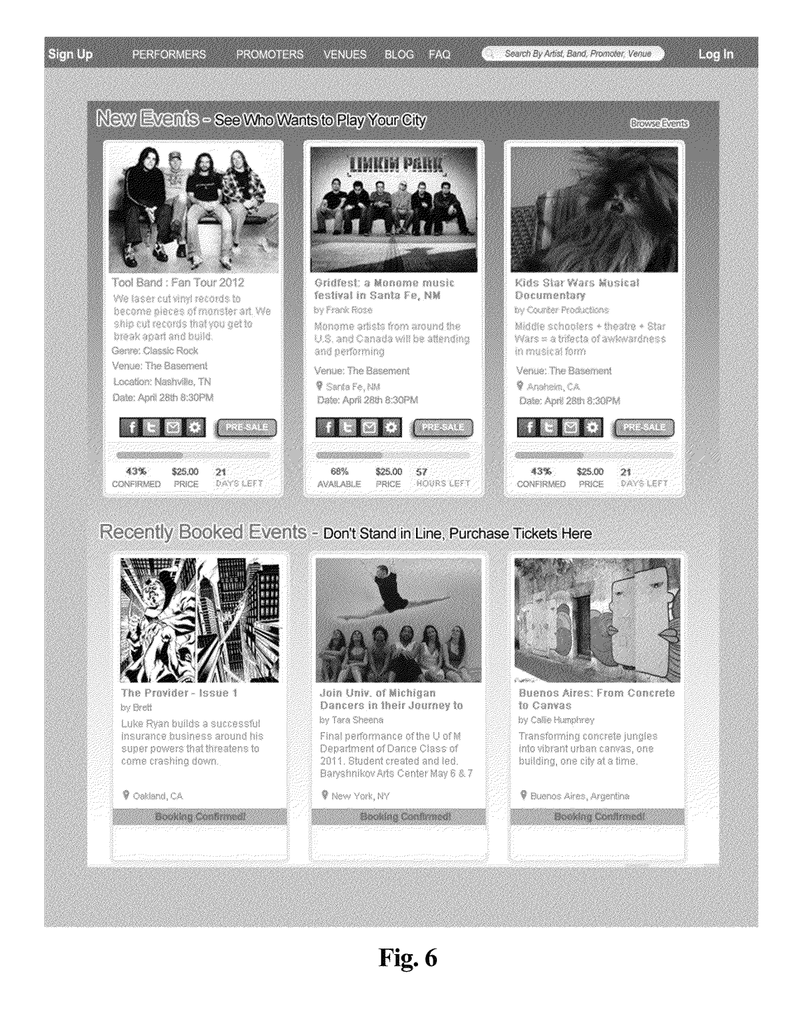

FIG. 6 depicts an embodiment of a dashboard that allows registered fans to browse events for which tentative ticket reservations are being offered, accept tentative ticket reservations, track the progress of an event towards reaching the tentative ticket threshold, and purchase tickets for confirmed events (events for which a threshold has been reached), send invitations to register with the system, and share events through social media, etc.

In the manner described herein, venue operators, performers and promoters can alleviate a risk of booking an undersold event by offering tentative ticket reservations to consumers. The venue operators, performers and promoters can reach an agreement on a threshold relating to the tentative ticket reservations such that if the threshold is achieved, then the event is booked, each tentative ticket reservation is executed, and the consumer is charged. If the threshold is not achieved, the event is abandoned and each tentative ticket reservation is cancelled. The present invention allows venue operators to avoid booking shows that will be undersold. At the same time, unknown or out of town performers have a chance at booking a venue. The present invention further leverages social media to facilitate in making this determination and generating interest for the event before it is booked.

The present invention has been described in terms of specific embodiments incorporating details to facilitate the understanding of principles of construction and operation of the invention. Such reference herein to specific embodiments and details thereof is not intended to limit the scope of the claims appended hereto. It will be apparent to those skilled in the art that modifications may be made in the embodiment chosen for illustration without departing form the spirit and scope of the invention. Specifically, it will be apparent to those skilled in the art that while the preferred embodiment of the present invention is accessible over the internet through the public switched telephone network, the present invention could also be accessible on any other appropriate communication structures, including intranets, direct connections and the like.

What is claimed is:

1. A method of booking a venue for an event and selling tickets to the event while alleviating a risk that the event will be undersold, comprising:
obtaining, at a network server, a request to book a venue for an event from a performer, venue operator, or promoter;
facilitating an agreement on a threshold relating to tentative ticket reservations that must be achieved within a certain time period before the event is confirmed; and
offering to consumers, tentative ticket reservations to the event subject to the condition that if the threshold is achieved, each tentative ticket reservation becomes a final sale, and if the threshold is not achieved, the tentative ticket reservation is cancelled.

2. The method of claim 1 wherein the request to book a venue for an event is from a performer.

3. The method of claim 2 wherein facilitating an agreement comprises allowing the performer to make a threshold proposal for acceptance by the promoter or venue operator.

4. The method of claim 3 wherein facilitating an agreement further comprises allowing the venue operator or promoter to make a threshold counter-proposal if the proposal is not accepted.

5. The method of claim 1 wherein the request to book a venue for an event is from a venue operator.

6. The method of claim 5 wherein facilitating an agreement comprises allowing the venue operator to make a threshold proposal for acceptance by the performer or promoter.

7. The method of claim 6 wherein facilitating an agreement further comprises allowing the performer or promoter to make a threshold counter-proposal if the proposal is not accepted.

8. The method of claim 1 wherein the request to book a venue for an event is from a promoter.

9. The method of claim 8 wherein facilitating an agreement comprises allowing the promoter to make a threshold proposal for acceptance by the performer or venue operator.

10. The method of claim 9 wherein facilitating an agreement further comprises allowing the performer or venue operator to make a threshold counter-proposal if the proposal is not accepted.

11. A system for booking a venue for an event and selling tickets to the event while alleviating a risk that the event will be undersold, comprising:
a registration engine configured to obtain, at a network server, a request to book a venue for an event from a performer, venue operator, or promoter;
a pre-sale agreement engine configured to facilitate an agreement on a threshold relating to tentative ticket reservations that must be achieved within a certain time period before the event is confirmed; and
a sale engine configured to offer tentative ticket reservations to the event subject to the condition that if the threshold is achieved, each tentative ticket reservation becomes a final sale, and if the threshold is not achieved, the tentative ticket reservation is cancelled.

12. The method of claim 11 wherein the request to book a venue for an event is from a performer.

13. The method of claim 12 wherein the pre-sale agreement engine is configured to allow the performer to make a threshold proposal for acceptance by the performer or venue operator.

14. The method of claim 13 wherein the pre-sale agreement engine is further configured to allow the venue operator or promoter to make a threshold counter-proposal if the proposal is not accepted.

15. The method of claim 11 wherein the request to book a venue for an event is from a venue operator.

16. The method of claim 15 wherein the pre-sale agreement engine is configured to allow the venue operator to make a threshold proposal for acceptance by the performer or promoter.

17. The method of claim 16 wherein the pre-sale agreement engine is further configured to allow the performer or promoter to make a threshold counter-proposal if the proposal is not accepted.

18. The method of claim 11 wherein the request to book a venue for an event is from a promoter.

19. The method of claim 18 wherein the pre-sale agreement engine is configured to allow the promoter to make a threshold proposal for acceptance by the performer or venue operator.

20. The method of claim 19 wherein the pre-sale agreement engine is further configured to allow the performer or venue operator to make a threshold counter-proposal if the proposal is not accepted.

21. A method of booking a venue for an event and selling tickets to the event while alleviating a risk that the event will be undersold, comprising:
obtaining, at a network server, a request to book a venue for an event from a performer;
facilitating an agreement on a threshold relating to tentative ticket reservations that must be achieved within a certain time period before the event is confirmed, the facilitating an agreement further comprising allowing the performer to make a threshold proposal for acceptance by a promoter or a venue operator, and allowing the venue operator or the promoter to make a threshold counter-proposal if the proposal is not accepted; and
offering to consumers, tentative ticket reservations to the event subject to the condition that if the threshold is achieved, each tentative ticket reservation becomes a final sale, and if the threshold is not achieved, the tentative ticket reservation is cancelled.
